(19) United States
(12) Patent Application Publication
(10) Pub. No.: US 2010/0239716 A1
(43) Pub. Date: Sep. 23, 2010

(54) TEA AROMATIZATION

(75) Inventors: Rainer Barnekow, Mariennunster (DE); Martina Batalia, Boffzen (DE)

Correspondence Address: CONNOLLY BOVE LODGE & HUTZ LLP, 1875 EYE STREET, N.W., SUITE 1100, WASHINGTON, DC, 20006, US

(73) Assignee: SYMRISE GmbH & Co., KG, Holzminden (DE)

(21) Appl. No.: 12/161,416

(22) PCT Filed: Dec. 4, 2006
(86) PCT No.: PCT/EP2006/069269

§ 371 Date: Apr. 16, 2010

(30) Foreign Application Priority Data
Jan. 23, 2006 (DE) 10 2006 003 335.3

(51) Int. Cl. A23F 3/40; A23L 1/22

(52) U.S. Cl. 426/78; 426/533

(57) ABSTRACT

The present invention relates to tea aromatized with aroma particles, the production and use thereof.

### CROSS-REFERENCE TO RELATED APPLICATIONS

This application claims benefit of priority to PCT/EP2006/069269, filed on Dec. 4, 2006, which asserts priority to DE 10 2006 003 335.3, filed on Jan. 23, 2006, which are incorporated herein by reference in their entireties.

The present invention relates to tea aromatized with aroma particles, the production and use thereof.

Tea for the purposes of the present invention is both the tea produced from leaves, leaf buds and/or tender stalks of the tea plant Camellia sinensis (tea plant) using conventional methods (tea in the narrower sense), and also plant parts which do not come from the tea plant and which are prepared and intended for use in the manner of tea in the narrower sense (tea in the broader sense), as well as mixtures of tea in the broader and narrower senses. The term “tea particles” is understood hereafter as meaning both particles of tea in the narrower sense and plant parts of tea in the broader sense, in particular optionally fermented tea leaves and fragments thereof

For the purposes of the present invention, tea or tea leaves are taken in particular to mean a leaf tea of the leaf grade “broken”, “fannings” or “dust”. Fannings are small leaf pieces left over from sieving and used almost exclusively for tea bags. Fannings conventionally have a tea leaf or particle size ranging from 0.5 to 2 mm and frequently of 0.7 to 1.5 mm. Teas of the leaf grade “broken” conventionally include constituents with a tea leaf or particle size of up to 1.5 cm.

Tea in the narrower sense is especially black tea, oolong tea, green tea, including pu-erh tea, and yellow tea. Tea in the broader sense is in particular fruit and/or herb tea based for example on rooibos, rose hip, hibiscus, apple, orange, peppermint or balm.

It has long been known to aromatize tea in the narrower and broader sense, conventionally using either liquid aromas (e.g. DE 30 06 092, DE 39 31 094), solid aromas (e.g. DE 37 01 230, with a grain size therein of 0.2-2 mm), i.e. aromas applied to solid carriers or enclosed in solid carriers, or also small pieces of dried plants.

In the case of liquid aromas, the aroma is not protected from evaporation or oxidation; also, aromatization with liquid aromas may lead to undesirable agglomeration of the tea. When aromatizing tea with solid aromas, granules or agglomerated powders are used, since these larger particles have less of a tendency to segregate. Conventional particle sizes of aroma granules are 500 μm to 2 mm.

EP 0 499 858 describes the aromatization of tea, a microencapsulated aroma being mixed with an oil or fat and/or emulsifier until larger, aggregated particles are obtained, which must have at least an average particle size of 150 micrometers. These larger, aggregated particles are then mixed with the tea to be aromatized. According to EP 0 499 858, oil or fat and/or emulsifier are used to form larger, aggregated particles, not to improve the cohesion and/or adhesion of aroma particles and tea particles.

In GB 2 074 838, cyclodextrin complexes containing aroma substances are kneaded with glycerol and water and with a solid binder such as dextran, soluble starch, gum arabic or specific cellulose derivatives and optionally tea dust to yield a paste which is then granulated and dried. The resultant granular product is sieved to yield a particle size ranging from 0.5-1 mm. Such granular fractions are finally mixed with tea leaves for filling tea bags. The resultant mixture is intended to be stable against segregation. GB 2 074 838 relates to a dry mixture, which is free of neutral oil for the purposes of the present invention.

U.S. Pat. No. 4,880,649 proposes to aromatize tea by spraying it with a liquid emulsion containing emulsified liquid aroma and a carrier, for example (modified or degraded) starches such as maltodextrins.

The as yet unpublished DE 10 2004 036 187 relates to tea aromatized with a spray-dried aroma using neutral oil, the spray-dried aroma preferably having an average particle size (median value) of 10 to 100 micrometers.

An alternative or simple method of aromatizing tea with a solid aroma has now been sought which does not result in segregation of the tea and the solid aroma.

The present invention accordingly provides a method of aromatizing tea, having the following step:
mixing
(i) tea particles to be aromatized,
(ii) aroma particles with an average particle size in the range from 200-600 micrometers with
(iii) a neutral oil.

The wetting of the tea particles, in particular tea leaves, with neutral oil and the subsequent addition of aroma particles largely prevents the tea particles and aroma particles from segregating. Segregation may be largely avoided by the adhesion and cohesion (brought about by the neutral oil) of the aroma particles and tea leaves.

The aroma particles used according to the invention have an average particle size (median value) of 200 to 600 micrometers, preferably a median value of greater than or equal to 200 and less than 500 micrometers, particularly preferably a median value of greater than or equal to 250 and less than or equal to 450 micrometers. The segregation of tea particles (in particular tea leaves) and aroma particles is avoided to the greatest degree in the latter range.

The most extensive to complete absence of segregation is particularly noticeable in the case of aromatized tea in the narrower sense and in particular in the case of broken and fannings grade tea, most particularly in the case of teas of the leaf grade “fannings” (with a particle size in the range from 0.5 to 2 mm). It has surprisingly been noted that aroma particles with an average particle size in the above-stated range, in particular with an average particle size in the range from 250 to 450 μm, display particularly stable behavior with regard to segregation with tea constituents wetted with neutral oil. The adhesion and/or cohesion brought about by the addition according to the invention of the neutral oil gives the tea according to the invention an improved and very favorable flow behavior (rheology), such that the tea has only a very slight tendency towards segregation.

The advantageous amount of aroma particles is 0.1 to 8 wt. %, preferably 0.5 to 5 wt. %, particularly preferably 0.8 to 4 wt. %, relative to the weight of the tea particles or tea leaves.

In the broader sense of the present invention, “neutral oil” is understood to mean a substantially flavor-neutral triglyceride (triester of glycerol), such as for example a vegetable oil or triacetin (glycerol triacetate). Triglyceride neutral oils display excellent spreading behavior and are not hygroscopic, so (very largely) avoiding the undesired agglomeration of tea particles and tea leaves or indeed of aroma particles.

“Neutral oil” in the narrower sense of the present invention is understood to mean a substantially flavor-neutral triglyceride with identical or different C₂ to C₁₈ fatty acid residues. Particularly suitable are flavor-neutral triglycerides with identical or different C₆ to C₁₂ fatty acid residues (MCT, medium-chain triglycerides), which have excellent spreading and wetting properties with regard to the tea particles to be aromatized.

The preferred amount of neutral oil is 0.1 to 5 wt. %, particularly preferably 0.5 to 2 wt. %, relative to the weight of the tea particles, in particular the tea leaves. The tea particles are then sufficiently wetted without this leading to undesired oiling of the tea, in particular on brewing.

In addition, a fragrance or aroma substance may be added to the neutral oil, to aromatize or odorize the tea. This fragrance or aroma substance may be solid or liquid.

The method according to the invention may be performed by simultaneously introducing tea and aroma particles into a mixer, preferably a fluidizing mixer, and combining them with neutral oil by mixing.

Generally speaking, however, the best results are achieved with a method according to the invention in which the tea particles to be aromatized are introduced into a, preferably fluidizing, mixer. Examples of typical mixers are plowshare mixers (in particular those made by Lödige) or multistream fluid mixers (in particular those made by Gericke). After fluidization of the tea particles to be aromatized by the mixer, the neutral oil is sprayed onto the tea particles by means of a nozzle. The aroma particles are then added to the fluidized tea. This leads to distribution and cohesion and/or adhesion of aroma particles and tea particles.

The mixture is generally mixed further until the aroma particles and tea particles are sufficiently distributed.

The present invention therefore relates in particular to a method of aromatizing tea, comprising the steps:
a) introducing tea leaves and/or tea particles to be aromatized,
b) providing the introduced tea leaves or particles with a neutral oil for wetting the surface of the tea particles, and
c) mixing in aroma particles with an average particle size in the range from 200-600 micrometers with the tea particles wetted with the neutral oil.

The tea particles and/or tea leaves aromatized in this simple, cost-effective manner have a protected aroma and additionally a very low dust content.

By virtue of said properties, the tea particles and/or tea leaves aromatized according to the invention are particularly suitable for filling into, and use in, tea bags.

The invention therefore further relates to tea bags containing tea aromatized according to the invention, especially tea of the leaf grade “fannings” and/or “broken” aromatized according to the invention.

Particularly preferably, the method is carried out by
a) introducing tea particles, in particular of the leaf grade “fannings” and/or “broken”, preferably into a fluidizing mixer,
b) applying a neutral oil, which is a triglyceride with identical or different C₂ to C₁₈ fatty acid esters, to the preferably fluidized tea particles,
c) adding aroma particles with an average particle size in the range from 200-600 micrometers, preferably in the range from greater than or equal to 250 and less than or equal to 450 micrometers, to the tea particles treated with neutral oil,
   and
d) optionally continuing to mix the resulting mixture.

The further mixing may be used in particular to mix further constituents into the tea. The subsequent mixing of further constituents into a tea aromatized according to the invention is particularly advantageous if these constituents do not withstand mixing stress of long duration, examples being flowers and other fragile constituents.

Aromas for aromatizing tea according to the invention are usually liquid mixtures generally of volatile components, said mixtures usually being of complex composition. Granules or particles containing aroma substances are required for various purposes and represent a common form of presentation in the aroma industry.

The encapsulation of aromas by means of spray drying, as described for example in U.S. Pat. No. 3,159,585, U.S. Pat. No. 3,971,852, U.S. Pat. No. 4,532,145 or U.S. Pat. No. 5,124,162, is conventional in the industry. Aroma particles are commercially available in many different flavor directions and particle sizes.

Relatively small particles, such as for example spray-dried aromas, may if necessary be formed by agglomeration, whether by dry agglomeration or wet agglomeration, into larger aroma particles.

The method of press agglomeration is understood to mean dry agglomeration, in which, in the usual case of a dry bed, relatively small particles are compressed by pressing tools into larger particles, the pressed agglomerate. Here, in contrast to wet agglomeration, no material bridges are formed and no binders are added.

Roll presses or other presses may be used to carry out press agglomeration, roll pressing with a roller compactor with smooth rollers or shaping rollers being conventional, for example. Press agglomeration may proceed by compression or by extrusion.

Glassy aroma particles produced by means of extrusion, as described for example in WO 2003/092412, EP 1 123 660 or EP 1 034 705, are also conventional in the industry.

Likewise conventional in the industry is aroma encapsulation by the fluidized bed method, as described for example in WO 2000/36931 or WO 97/16078. Aroma particles produced by the fluidized bed method are commercially available in many different flavor directions and particle sizes.

The particles preferred for the purposes of the present invention have a high degree of sphericity.

Said sphericity corresponds, as per H. Wadell (“Volume, Shape and Roundness of Rock Particles”; Journal of Geology 40 (1932) 443-451), to the ratio between the surface of a sphere of identical volume and the actual surface. By definition, said sphericity may assume numerical values in the range from >0 to 1. Aroma particles preferred according to the invention exhibit a sphericity of greater than or equal to 0.75, particularly preferably of greater than or equal to 0.90.

For the purposes of the present invention, aroma particles with elevated sphericity are preferably produced by a fluidized bed method, preferably by means of fluidized bed spray granulation. Particular preference is given, for the purposes of the present invention, to fluidized bed spray granulation with internal nucleation, as described for example in WO 00/36931 or U.S. Pat. No. 4,946,654.

A particularly suitable method for fluidized bed spray granulation and an apparatus for this method are for known example from U.S. Pat. No. 4,946,654. Such an apparatus substantially consists of a fluidized bed granulator
which contains devices for atomization of the product supplied in sprayable form,
which additionally contains a system suitable for returning fines escaping from the fluidized bed and
to the distributor base plate of which one or more countercurrent gravity classifiers are attached.

Granules with a narrow grain size distribution may in turn preferably be produced in that
a) the product to be granulated is sprayed into a fluidized bed in liquid form,
b) the fines escaping from the fluidized bed with the exhaust gas are separated off and returned to the fluidized bed as nuclei for granule formation,
c) the granulation process in the fluidized bed is influenced in such a way, solely by adjusting the classifying gas flow, that granules arise in the size predetermined by the classifying gas flow, and
d) the finished granular product is removed solely via one or more countercurrent gravity classifiers inserted into the distributor base plate of the fluidized bed apparatus, and
e) the resultant granules are optionally subjected to a thermal post-treatment.

Advantageously, the method of producing the aroma particles may be carried out in such a way that, in the interplay between granule growth and nucleation, the granule formation process is automatically adjusted to the size of discharged granules predetermined by the classifying gas feed. In this way, the size of the granules may be adjusted by means of the classifying discharge. These embodiments of the method are described for example in EP 0 332 031 and EP 0 332 929. In principle, the method may also be performed continuously or batchwise by means of standard granulators. Classification may likewise proceed separately and downstream with sieves or other classifiers. Nucleus material may be produced for example by grinding.

Conventional aroma particles comprise at least one carrier, an aroma or an individual aroma substance and further substances, such as for example an emulsifier.

The aroma loading in the aroma particles to be used according to the invention may be widely varied, depending on requirements and the desired organoleptic profile. Aroma loading conventionally lies in the range from 1 to 50 wt. %, generally in the range from 5 to 30 wt. %, relative to the total weight of the aroma particle.

The carriers for the aromas in the aroma particles to be used according to the invention may comprise individual substances or mixtures of substances.

Advantageous aroma particles comprise carbohydrates and/or carbohydrate polymers (polysaccharides) as carriers. Examples which may be mentioned of preferred carriers in the aroma particles to be used according to the invention are hydrocolloids such as starches, degraded starches, chemically or physically modified starches, modified celluloses, gum arabic, gum ghatti, tragacanth, karaya, carrageenan, guar flour, locust bean flour, alginates, pectin, inulin or xanthan gum, dextrins and maltodextrins.

Preferably, the aroma particles to be used according to the invention, as well as the tea according to the invention, do not contain any cyclodextrins.

The degree of degradation of the starch is measured with the “dextrose equivalent” (DE) index, which may adopt the limit values 0 for the long-chain glucose polymer starch and 100 for pure glucose.

Particularly preferred carriers in the aroma particles to be used according to the invention are maltodextrins, maltodextrins with DE values in the range from 10 to 30 here in turn being advantageous.

Fluidized bed spray granulation, which is preferred, is generally performed as follows: firstly the carrier material, preferably dextrin or a maltodextrin, is dissolved in water. Emulsifier and the aroma are added to the aqueous solution, homogenization of the mixture by intensive mechanical mixing having proven effective. The emulsion is then spray-granulated in the fluidized bed (with constant stirring).

Examples of possible aromas are essential oils, fractions thereof or individual aroma substances.

Examples which may be mentioned are: extracts of natural raw materials such as essential oils, concretes, absolutes, resins, resinoids, balsams, tinctures such as anise oil; bergamot oil; lemon oil; eucalyptus oil; grapefruit oil; camomile oil; lime oil; clove bud oil, orange oil; peppermint oil; rosemary oil; sage oil; star anise oil; thyme oil; vanilla extract; juniper berry oil; wintergreen oil; cinnamon leaf oil; cinnamon oil; and fractions thereof, or ingredients isolated therefrom.

Individual aroma substances which may be constituents of the aroma come for example from the following material classes: aliphatic esters (saturated and unsaturated), for example ethyl butyrate, allyl caproate; aromatic esters, for example benzyl acetate, methyl salicylate; organic aliphatic acids (saturated and unsaturated), for example acetic acid, caproic acid; organic aromatic acids; aliphatic alcohols (saturated and unsaturated); cyclic alcohols, for example menthol; aromatic alcohols, for example benzyl alcohol; aliphatic aldehydes (saturated and unsaturated), for example acetaldehyde; aromatic aldehydes, for example benzaldehyde; vanillin; ketones, for example menthone; cyclic ethers, for example 4-hydroxy-5-methylfuranone; aromatic ethers, for example p-methoxybenzaldehyde, guajacol; lactones, for example gamma-decalactone; terpenes, for example limonene, linalool, terpinene, terpineol, citral.

Aromas preferred for the purposes of the present invention are: berry fruits (for example raspberry aromas, strawberry aromas), citrus fruits, pomaceous fruit, vanilla, spices (for example cinnamon, cloves), herbs, (for example thyme, rosemary, sage, chamomile), mint. Particularly preferred aromas are lemon, bergamot and orange aromas. When applied in liquid form to tea, these aromas are very prone to oxidation and therefore lead readily to undesired organoleptic off notes. With the method according to the invention, teas, in particular teabag teas, may be produced in which the tendency to produce organoleptic off notes is greatly reduced without the tea and the aroma becoming segregated.

The mixture for producing the aroma particles to be used according to the invention may also contain conventional additives and ingredients such as foodstuff dyes, sweeteners, antioxidants, edible acids such as citric acid, flavor-influencing substances such as sodium glutamate, vitamins, minerals, juice concentrates etc., such that the aroma particles used according to the invention may also comprise such additives.

The invention is explained in greater detail with reference to the following Examples, without the subject matter of the invention or the scope of protection being restricted by said Examples. Unless otherwise stated, all stated values relate to weight.

### EXAMPLE 1

A solution consisting of 44 wt. % water, 11 wt. % bergamot oil aroma, 13 wt. % gum arabic and 32 wt. % hydrolyzed starch (maltodextrin, DE 15-19) and some dye is granulated in a granulating apparatus of the type described in EP 163 836 (with the following features: distributor base plate diameter: 225 mm, spray nozzle: two-fluid nozzle; classifying discharge: zigzag classifier; filter: internal bag filter). The solution is sprayed into the fluidized bed granulator at a temperature of 32° C. The bed contents are fluidized by blowing in nitrogen in a quantity of 140 kg/h. The inlet temperature of the fluidizing gas is 140° C. The temperature of the exhaust gas is 76° C. The pneumatic classifying gas used is likewise nitrogen in an amount of 15 kg/h with a temperature of 50° C. The contents of the fluidized bed amounts to approx. 500 g. Granulation output amounts to approx. 2.5 kg per hour. Free-flowing granules are obtained having an average particle diameter of 420 micrometers. The granules are round and exhibit a smooth surface. On the basis of the constant pressure drop of the filter and of the likewise constant bed contents, steady-state conditions may be assumed to prevail with regard to the granulation process.

850 g of black tea fannings are introduced into a 5 liter Lödige plowshare mixer. The tea leaves are premixed for 10 seconds and fluidized.

Without interrupting the mixing process, 6 g of a fine neutral oil mist (MCT oil aerosol) is sprayed onto the fluidized tea leaves by means of a one- or two-fluid nozzle. This takes approx. 60 seconds.

Without interrupting the mixing process, 40 g of the above-stated orange-colored aroma particles with bergamot oil aroma are then added to the mixture and the entire mixture is mixed for a further 60 seconds.

### EXAMPLE 2

A solution consisting of 50 wt. % water, 11 wt. % gum arabic, 22.5 wt. % hydrolyzable starch (maltodextrin, DE 15-19) and 16.5 wt. % vanilla aroma and a small amount of dye is granulated in the apparatus described in Example 1. The solution is sprayed into the fluidized bed granulator at a temperature of 32° C. The bed contents are fluidized by blowing in nitrogen in an amount of 110 kg/h. The inlet temperature of the fluidizing gas is 130° C. The temperature of the exhaust gas is 84° C. The classifying gas used is likewise nitrogen in an amount of 9 kg/h with a temperature of 81° C. The contents of the fluidized bed amounts to approx. 500 g. Granulation output amounts to approx. 1.5 kg per hour. Free-flowing granules are obtained having an average particle diameter of 350 micrometers. The granules are round and have a moderately smooth surface (partially with secondary agglomerates).

800 g of rooibos tea are introduced into a 5 liter Lödige plowshare mixer. The tea leaves are premixed for 10 seconds and fluidized.

Without interrupting the mixing process, 5 g of a fine neutral oil mist (MCT oil aerosol) is sprayed onto the fluidized tea leaves by means of a one- or two-fluid nozzle. This takes approx. 60 seconds.

Without interrupting the mixing process, 33 g of the above-stated aroma particles with vanilla aroma are added to the mixture and the entire mixture is mixed for a further 60 seconds.

### EXAMPLE 3

### Determining the Degree of Segregation

Segregation of a solids mixture is understood to mean the undesired separation of one or more components from the mixture.

Segregation generally arises as a result of vibration, transfer, transportation or other movement of the mixture.

The tendency of the mixture to segregate was assessed as follows:
a) visually: visual comparison of a plurality of random samples regarding distribution of the aroma in the tea
b) by organoleptic tasting: various random samples of the mixture were tested by a panel using a triangle difference test and the organoleptic deviation regarding aroma intensity was assessed.

These tests revealed the two teas according to the invention of Examples 1 and 2 to be stable against segregation.

### Specific Embodiments

In specific embodiment one, the invention comprises a method of aromatizing tea, comprising mixing of
tea particles to be aromatized and
aroma particles with an average particle size of 200 to 600 μm with a neutral oil.

In specific embodiment two, the invention comprises the method as in specific embodiment one, wherein first of all the tea particles to be aromatized and optionally the aroma particles are initially introduced, and then mixed with the neutral oil.

In specific embodiment three, the invention comprises the method as in specific embodiment one or specific embodiment two, wherein the tea particles to be aromatized have a particle size of up to 1.5 cm and preferably a particle size of 0.5 mm to 1.5 cm.

In specific embodiment four, the invention comprises the method as in any one of the preceding specific embodiments, wherein the tea particles are fluidized for provision with the neutral oil.

In specific embodiment five, the invention comprises the method as in any one of the preceding specific embodiments, wherein the neutral oil is a triglyceride, preferably a triglyceride with C₂-C₁₈ fatty acid residues.

In specific embodiment six, the invention comprises the method as in any one of the preceding specific embodiments, wherein the aroma particles exhibit a sphericity of greater than or equal to 0.75.

In specific embodiment seven, the invention comprises the method as in any one of the preceding specific embodiments, wherein the aroma particles are produced by means of fluidized bed spray granulation.

In specific embodiment eight, the invention comprises the method as in any one of the preceding specific embodiments, wherein the aroma particles comprise as carriers carbohydrates and/or carbohydrate polymers, preferably maltodextrins.

In specific embodiment nine, the invention comprises use of aroma particles with an average particle size (median value) of 200 to 600 μm to aromatize tea particles provided with neutral oil.

In specific embodiment ten, the invention comprises an aromatized tea, produced or producible as in any one of the preceding specific embodiments.

In specific embodiment eleven, the invention comprises a tea bag containing an aromatized tea as in specific embodiment ten.

It is claimed:

1. A method of aromatizing tea, comprising mixing of
tea particles to be aromatized and
aroma particles with an average particle size of 200 to 600 μm with a neutral oil.

2. The method as claimed in claim 1, wherein first of all the tea particles to be aromatized and optionally the aroma particles are initially introduced, and then mixed with the neutral oil.

3. The method as claimed in claim 1, wherein the tea particles to be aromatized have a particle size of up to 1.5 cm.

4. The method as claimed in claim 1, wherein the tea particles are fluidized for provision with the neutral oil.

5. The method as claimed in claim 1, wherein the neutral oil is a triglyceride.

6. The method as claimed in claim 1, wherein the aroma particles exhibit a sphericity of greater than or equal to 0.75.

7. The method as claimed in claim 1, wherein the aroma particles are produced by means of fluidized bed spray granulation.

8. The method as claimed in claim 1, wherein the aroma particles comprise as carriers carbohydrates and/or carbohydrate polymers.

9. A method for aromatizing tea particles comprising mixing aroma particles with an average particle size (median value) of 200 to 600 μm with neutral oil.

10. An aromatized tea, produced or producible as claimed in claim 1.

11. A tea bag containing an aromatized tea as claimed in claim 10.

12. The method of claim 3, wherein the particle size is 0.5 mm to 1.5 cm.

13. The method of claim 5, wherein the triglyceride has C₂-C₁₈ fatty acid residues.

14. The method of claim 8, wherein the carrier comprises maltodextrins.
